(19) United States
(12) Patent Application Publication
(10) Pub. No.: US 2024/0161551 A1
(43) Pub. Date: May 16, 2024

(54) NOTIFICATION DEVICE

(71) Applicant: TOYOTA JIDOSHA KABUSHIKI KAISHA, Toyota-shi (JP)

(72) Inventors: Shusuke YAMAMOTO, Tokyo (JP); Chikara OKAZAKI, Gotemba-shi (JP); Kohta WATATSU, Nagoya-shi (JP); Hideyuki TANAKA, Nisshin-shi (JP); Shinya MURASE, Nagoya-shi (JP); Yuki TATSUMOTO, Seto-shi (JP)

(73) Assignee: TOYOTA JIDOSHA KABUSHIKI KAISHA, Toyota-shi (JP)

(21) Appl. No.: 18/375,760

(22) Filed: Oct. 2, 2023

(30) Foreign Application Priority Data
Nov. 16, 2022 (JP) 2022-183401

(51) Int. Cl. G07C 5/00; G07C 5/10

(52) U.S. Cl. CPC G07C 5/006; G07C 5/008; G07C 5/10

(57) ABSTRACT

A notification device includes: a travel information acquisition section that is configured to acquire travel information of a vehicle; an environment information acquisition section that is configured to acquire, from satellite data, environment information at a location at which the vehicle has been present, based on the travel information of the vehicle which is acquired by the travel information acquisition section; an estimation section that is configured to estimate a degree of contamination and tarnishing of the vehicle based on the environment information which is acquired by the environment information acquisition section; and a notification section that is configured to notify a user of the vehicle of a timing for at least one of a vehicle wash or a vehicle inspection, based on an estimation result by the estimation section.

### CROSS-REFERENCE TO RELATED APPLICATION

This application claims priority under 35 USC 119 from Japanese Patent Application No. 2022-183401 filed Nov. 16, 2022, the disclosure of which is incorporated by reference herein in its entirety.

### BACKGROUND

### Technical Field

The present disclosure relates to a notification device.

### Related Art

Japanese Patent Application Laid-Open (JP-A) No. 2015-191525 discloses a vehicle maintenance system that sets a schedule for a vehicle inspection, maintenance, a service, and the like based on data relating to a vehicle, such as travel distance, and notifies a user of a maintenance timing for the vehicle.

### SUMMARY

In the vehicle maintenance system disclosed in JP-A No. 2015-191525, environmental information at a location at which a vehicle has been present is not considered, and therefore, it is difficult to notify a user of an appropriate maintenance timing for the vehicle for, for example, a vehicle inspection and/or a vehicle wash.

In consideration of the above-described facts, the present disclosure provides a notification device that is capable of extending the operating life of a vehicle by notifying a user of an appropriate timing for a vehicle inspection and/or a vehicle wash.

### Means for Solving the Problem

A notification device according to a first aspect of the present disclosure includes: a travel information acquisition section that is configured to acquire travel information of a vehicle; an environment information acquisition section that is configured to acquire, from satellite data, environment information at a location at which the vehicle has been present, based on the travel information of the vehicle which is acquired by the travel information acquisition section; an estimation section that is configured to estimate a degree of contamination and tarnishing of the vehicle based on the environment information which is acquired by the environment information acquisition section; and a notification section that is configured to provide notification of a timing for at least one of a vehicle wash or a vehicle inspection, based on an estimation result by the estimation section.

The notification device according to the first aspect acquires, from satellite data, environment information at a location at which a vehicle has been present, based on travel information of the vehicle. The estimation section then estimates the degree of contamination and tarnishing of the vehicle based on the environmental information, and based on the estimation result, provides notification of a timing for at least one of a vehicle wash or a vehicle inspection. This enables the user to be informed of the timing for a vehicle wash and/or a vehicle inspection, based on the degree of contamination of the vehicle. As a result, the user can perform a vehicle wash and/or a vehicle inspection at an appropriate timing, enabling the operating life of the vehicle to be extended.

A notification device according to a second aspect of the present disclosure is the configuration of the notification device according to the first aspect, wherein: in a case in which the vehicle has traveled on at least one of a road on which yellow sand or volcanic ash is present, a rough road, an unpaved road, a coastal road or a snow-covered road, the estimation section is configured to set the degree of contamination and tarnishing higher than a case in which the vehicle has not traveled on the at least one of a road on which yellow sand or volcanic ash is present, a rough road, an unpaved road, a coastal road or a snow-covered road.

In the notification device according to the second aspect, in a case in which the vehicle has traveled on at least one of a road on which yellow sand or volcanic ash is present, a rough road, an unpaved road, a coastal road or a snow-covered road, the estimation section is configured to set the degree of contamination and tarnishing higher than a case in which the vehicle has not traveled on the at least one of a road on which yellow sand or volcanic ash is present, a rough road, an unpaved road, a coastal road or a snow-covered road. Accordingly, in a case in which the vehicle has traveled on a road that causes contamination and tarnishing, including soiling, degradation, wear, and the like, the degree of contamination and tarnishing becomes higher, enabling the user to be informed of an appropriate timing for a vehicle wash and/or a vehicle inspection in accordance with the environmental information at the location at which the vehicle has been present.

A notification device according to a third aspect of the present disclosure is the configuration of the notification device according to the first aspect or the second aspect, wherein: in a case in which a travel distance of the vehicle, per unit time, is equal to or less than a predetermined distance, the estimation section is configured to set the degree of contamination and tarnishing higher than a case in which the travel distance, per unit time, is greater than the predetermined distance.

In the notification device according to the third aspect, the estimation section is configured to set the degree of contamination and tarnishing higher in a case in which the vehicle travels so-called short distances. In general, when a vehicle travels short distances, it is desirable to replace the engine oil or the battery at a shorter cycle than usual. As a result, according to the notification device of the present disclosure described in claim 3, information as to whether or not the vehicle has traveled short distances is also considered with respect to the timing for a vehicle inspection, enabling the user to be informed of a more appropriate timing for a vehicle inspection.

A notification device according to a fourth aspect of the present disclosure is the notification device according to any one of the configuration of the first aspect to the third aspect, wherein: the notification section is configured to provide notification of the timing with respect to a necessary maintenance item and a vehicle wash, based on at least one of a maintenance history of the vehicle or a vehicle wash history of the vehicle.

In the notification device according to the fourth aspect, the notification section is configured to provide notification of the timing for a vehicle wash and/or a vehicle inspection based on at least one of the maintenance history of the vehicle or the vehicle wash history of the vehicle, enabling the user to know the timing for a vehicle wash and/or a vehicle inspection for items requiring a vehicle wash and/or a vehicle inspection.

A notification device according to a fifth aspect of the present disclosure is the configuration of the notification device according to any one of the first aspect to the fourth aspect, wherein: the travel information acquisition section is configured to acquire the travel information of the vehicle based on satellite data acquired by capturing a code that is disposed at an upper part of the vehicle and that identifies the vehicle.

In the notification device according to the fifth aspect, the travel information acquisition section is configured to acquire the travel information of the vehicle based on satellite data acquired by capturing a code that is disposed at an upper part of the vehicle and that identifies the vehicle. This enables the vehicle to be identified from the satellite data acquired by capturing the code, enabling travel information of the vehicle to be acquired from the satellite data acquired in chronological order.

A notification device according to a sixth aspect of the present disclosure is a notification device for maintenance and safe travel of a vehicle. The notification device includes a memory, and a processor coupled to the memory, wherein the processor is configured to: acquire travel information of a vehicle; acquire, from satellite data, environment information at a location at which the vehicle has been present, based on the acquired travel information of the vehicle; estimate a degree of contamination and tarnishing of the vehicle based on the acquired environment information; and notify a user of the vehicle of a timing for at least one of a vehicle wash or a vehicle inspection, based on an estimation result.

A notification device according to a seventh aspect of the present disclosure is the configuration of the notification device according to the sixth aspect, wherein: in a case in which the vehicle has traveled on at least one of a road on which yellow sand or volcanic ash is present, a rough road, an unpaved road, a coastal road or a snow-covered road, the processor is configured to set the degree of contamination and tarnishing higher than a case in which the vehicle has not traveled on the at least one of a road on which yellow sand or volcanic ash is present, a rough road, an unpaved road, a coastal road or a snow-covered road.

A notification device according to an eighth aspect of the present disclosure is the configuration of the notification device according to the sixth aspect, wherein: in a case in which a travel distance of the vehicle, per unit time, is equal to or less than a predetermined distance, the processor is configured to set the degree of contamination and tarnishing higher than a case in which the travel distance, per unit time, is greater than the predetermined distance.

A notification device according to a ninth aspect of the present disclosure is the configuration of the notification device according to the sixth aspect, wherein: the processor is configured to provide notification of the timing with respect to a necessary maintenance item and a vehicle wash, based on at least one of a maintenance history of the vehicle or a vehicle wash history of the vehicle.

A notification device according to a tenth aspect of the present disclosure is the configuration of the notification device according to the sixth aspect, wherein: the processor is configured to acquire the travel information of the vehicle based on satellite data acquired by capturing a code that is disposed at an upper part of the vehicle and that identifies the vehicle.

As described above, the notification device according to the present disclosure has an excellent advantageous effect of enabling the operating life of a vehicle to be extended by providing notification of an appropriate timing for a vehicle inspection and/or a vehicle wash.

### BRIEF DESCRIPTION OF THE DRAWINGS

FIG. 1 is a diagram illustrating an example of a schematic configuration of a notification system according to an exemplary embodiment of the present disclosure;

FIG. 2 is a block diagram illustrating a hardware configuration of a vehicle according to an exemplary embodiment of the present disclosure;

FIG. 3 is a block diagram illustrating a hardware configuration of a center server according to an exemplary embodiment of the present disclosure;

FIG. 4 is a block diagram illustrating an example of a functional configuration of a CPU in a center server according to an exemplary embodiment of the present disclosure; and

FIG. 5 is a flowchart illustrating an example of a flow of notification processing according to an exemplary embodiment of the present disclosure.

### DETAILED DESCRIPTION

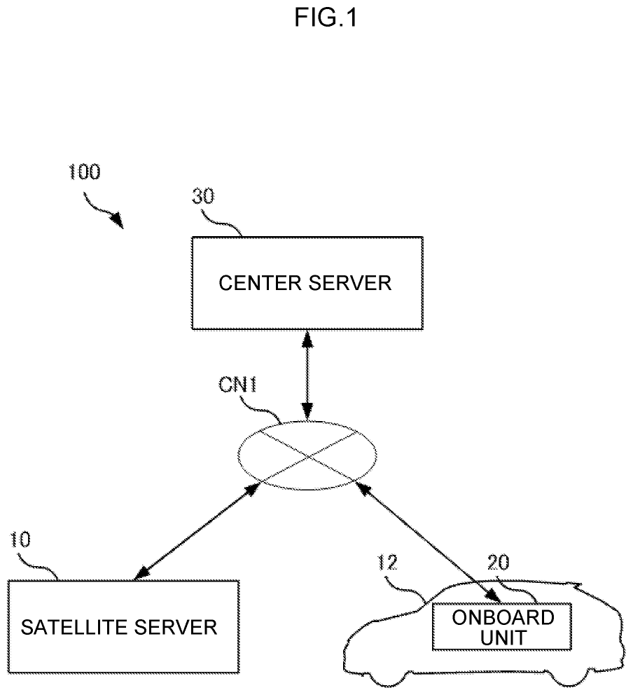

Explanation follows regarding a notification system 100 according to an exemplary embodiment of the present disclosure, with reference to the accompanying drawings. As illustrated in FIG. 1, the notification system 100 of the present exemplary embodiment includes a satellite server 10, a vehicle 12, and a center server 30. The center server 30 is an example of a notification device. Further, the vehicle 12 includes an onboard unit 20. Note that the number of vehicles 12 included in the notification system 100 is not limited to the number illustrated in FIG. 1. The satellite server 10, the vehicle 12, and the center server 30 are connected to each other via a network CN1.

The satellite server 10 accumulates various satellite data, including satellite images, which are terrestrial images captured from above by an artificial satellite, an aircraft, or the like, as well as weather images, such as infrared images, water vapor images, and visible images, captured by a weather satellite. The weather images enable the appearance of clouds at various locations around an area/country where the vehicle 12 locates to be confirmed by high resolution images. More specifically, the shape and brightness of clouds can be observed using the visible images, and the temperature of clouds, sea, and land can be observed using the infrared images. Moreover, the water vapor images enable the distribution of water vapor in the invisible atmosphere to be observed. The weather distribution is estimated and a weather forecast is performed by combining the aforementioned observation data.

The satellite server 10 associates and accumulates the satellite image, the date on which the satellite image was captured, and the location at which the satellite image was captured. Moreover, the satellite server 10 associates and accumulates the weather image, the date on which the weather image was captured, and the location at which the weather image was captured.

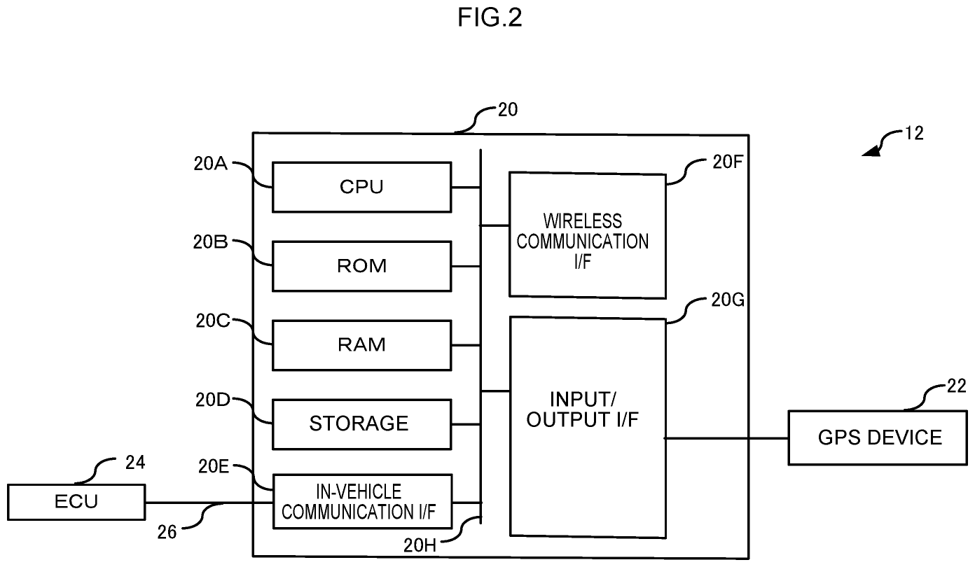

Next, explanation follows regarding a hardware configuration of the vehicle 12. The vehicle 12 of the present exemplary embodiment may be any of an internal combustion engine vehicle, a hybrid vehicle, or an electric vehicle. As illustrated in FIG. 2, the vehicle 12 includes the onboard unit 20, a global positioning system (GPS) device 22, and an electronic control unit (ECU) 24.

The GPS device 22 is a device that acquires position information that is a current location of the vehicle 12. The ECU 24 is a device that uses electronic circuits to control various systems of the vehicle 12.

The onboard unit 20 includes a central processing unit (CPU) 20A, read only memory (ROM) 20B, random access memory (RAM) 20C, storage 20D, an in-vehicle communication interface (I/F) 20E, a wireless communication I/F 20F, and an input/output I/F 20G. The CPU 20A, the ROM 20B, the RAM 20C, the storage 20D, the in-vehicle communication I/F 20E, the wireless communication I/F 20F, and the input/output I/F 20G are connected so as to be capable of communicating with each other via an internal bus 20H.

The CPU 20A is a central processing unit that executes various programs and controls various components. Namely, the CPU 20A reads a program from the ROM 20B or the storage 20D, and executes the program using the RAM 20C as a workspace. The CPU 20A controls the respective configurations described above and performs a variety of computation processing in accordance with programs stored in the ROM 20B or the storage 20D.

The ROM 20B stores various programs and various data. The RAM 20C serves as a workspace to temporarily store programs and data. The storage 20D is configured by a hard disk drive (HDD) or a solid state drive (SSD), and stores various programs including an operating system, as well as various data.

The wireless communication I/F 20F is an interface for connecting to the network CN1.

The in-vehicle communication I/F 20E is an interface for connecting to the ECU 24. A communication protocol based on the CAN protocol is used as the interface. The in-vehicle communication I/F 20E is connected to an external bus 26. Note that although not illustrated in the drawings, plural ECUs 24 are provided for each function of the vehicle 12.

The input/output I/F 20G is an interface for communicating with various devices installed at the vehicle 12. The onboard unit 20 of the present exemplary embodiment is connected to the GPS device 22 via the input/output I/F 20G. Note that the GPS device 22 may be directly connected to the bus 20H.

Center Server

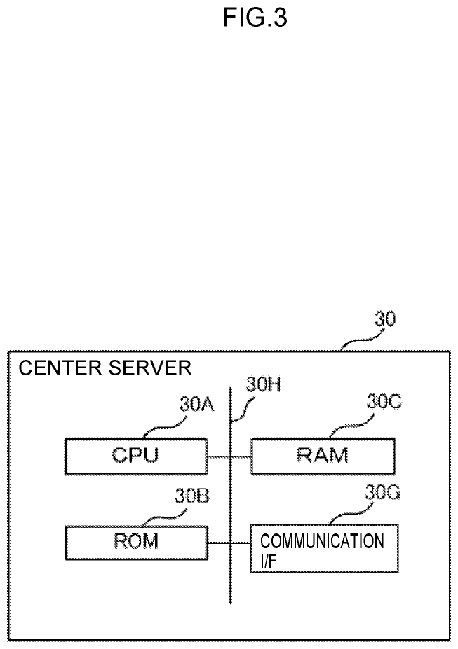

As illustrated in FIG. 3, the center server 30 includes a CPU 30A, ROM 30B, RAM 30C, and a communication I/F 30G. The CPU 30A, the ROM 30B, the RAM 30C, and the communication I/F 30G are connected so as to be capable of communicating with each other via an internal bus 30H.

The CPU 30A is a central processing unit that executes various programs and controls various components. Namely, the CPU 30A reads a program from the ROM 30B, and executes the program using the RAM 30C as a workspace.

The ROM 30B stores various programs and various data. The RAM 30C serves as a workspace to temporarily store programs and data.

The ROM 30B of the present exemplary embodiment stores a notification program, as well as a maintenance history, a vehicle wash history, and the like of the vehicle 12.

The notification program is a program to implement various functions of the center server 30.

As an example, the maintenance history of the vehicle 12 includes information such as the date and time when the vehicle was last inspected, the date and time when the engine oil was last replaced, the date and time when the battery was last replaced, and the date and time when the vehicle body was last coated. The maintenance history of the vehicle 12 can be updated via the network CN1. Note that the maintenance history of the vehicle 12 may be acquired via the network CN1.

The vehicle wash history of the vehicle 12 is information of the date and time when the vehicle was last washed. The vehicle wash history of the vehicle 12 is input by a user using, for example, a non-illustrated input means provided at the vehicle 12, and stored in the ROM 30B via the network CN1. Namely, after a vehicle wash, the user inputs information indicating that the vehicle wash has ended.

The communication I/F 30G is an interface for connecting to the network CN1.

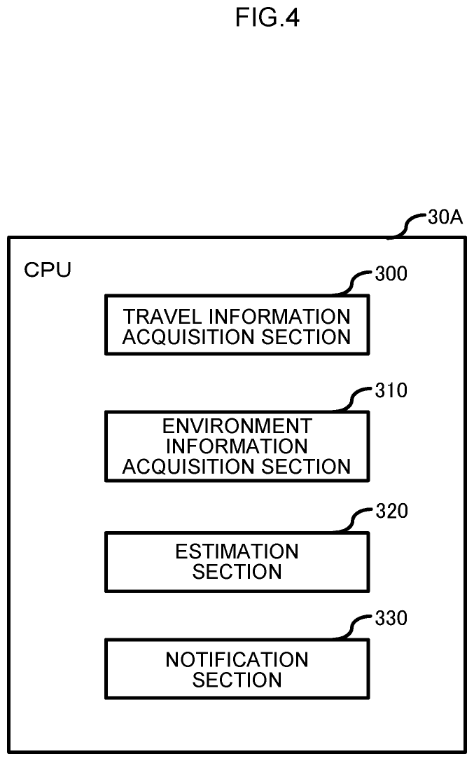

FIG. 4 is a block diagram illustrating an example of a functional configuration of the CPU 30A. As illustrated in FIG. 4, the CPU 30A includes a travel information acquisition section 300, an environment information acquisition section 310, an estimation section 320, and a notification section 330. Each functional configuration is implemented by the CPU 30A reading and executing an output program stored in the ROM 30B.

The travel information acquisition section 300 has a function of acquiring travel information of the vehicle 12. In the present exemplary embodiment, the travel information acquisition section 300 acquires travel information of the vehicle 12 from the onboard unit 20 via the communication I/F 30G. More specifically, the travel information acquisition section 300 acquires a history of the position information acquired by the GPS device 22 as travel information that the vehicle 12 has traveled. Note that the travel information is stored in a manner in which a history of position information and the date and time at which the positions were passed are associated with each other.

Note that acquisition of travel information of the vehicle 12 by the travel information acquisition section 300 is not limited to the example described above. For example, in a case in which a code such as a two-dimensional code or a mark that identifies the vehicle 12 is disposed at an upper part the vehicle 12, travel information of the vehicle 12 can be acquired based on satellite images in chronological order in which this code is captured.

The environment information acquisition section 310 acquires, from the satellite server 10, environment information at a location at which the vehicle 12 has been present, based on the travel information of the vehicle 12 that is acquired by the travel information acquisition section 300. More specifically, based on the travel information of the vehicle 12 that is acquired by the travel information acquisition section 300, the environment information acquisition section 310 acquires, from the satellite server 10, a weather image and a satellite image at the location and the date and time at which the vehicle 12 traveled. Based on the weather image and the satellite image acquired from the satellite server 10, the environment information acquisition section 310 acquires, as environment information, weather and environment information such as the presence or absence of yellow sand and volcanic ash at the location where the vehicle 12 traveled or visited, whether or not the location where the vehicle 12 traveled or visited included a rough road, an unpaved road, a coastal road, or a snow-covered road, and whether or not the location where the vehicle 12 traveled or visited included a muddy road. Note that a method of acquiring the relevant environment information from the weather images and the satellite images can be acquired using well-known image processing, analysis processing, or the like.

The estimation section 320 estimates the degree of contamination and tarnishing of the vehicle 12 based on the environment information that is acquired by the environment information acquisition section 310. Note that the “degree of contamination and tarnishing” includes the degree of tire wear, the degree of vehicle dirtiness, the degree of degradation of components and the like installed at the vehicle, the degree of battery consumption, and the like. More specifically, the degree of contamination and tarnishing is set higher in a case in which the vehicle traveled on at least one of a road on which yellow sand or volcanic ash is present, a rough road, an unpaved road, a coastal road, or a snow-covered path, namely a case in which the vehicle 12 traveled on a road that causes contamination and tarnishing including soiling, degradation, wear, and the like, compared to a case in which the vehicle 12 did not travel on such a road.

As an example, the estimation section 320 increases the degree of contamination and tarnishing as the amount of time spent by the vehicle 12 in an area including a road on which yellow sand, volcanic ash, or the like is present becomes greater. Moreover, as an example, the estimation section 320 increases the degree of contamination and tarnishing as the travel distance of the vehicle 12 in an area where rain, snow, or the like is falling, namely a rough road, becomes greater. Further, as an example, the estimation section 320 increases the degree of contamination and tarnishing as the travel distance of the vehicle 12 on an unpaved road with irregularities or the like becomes greater. Further, as an example, the estimation section 320 increases the degree of contamination and tarnishing as the travel time or the amount of time spent by the vehicle 12 on a coastal road, a snow-covered road, or the like becomes greater.

Moreover, as an example, in addition to that which is described above, in a case in which the travel distance of the vehicle 12, per unit time, is equal to or less than a predetermined distance, the estimation section 320 of the present exemplary embodiment sets the degree of contamination and tarnishing higher than a case in which the travel distance, per unit time, is greater than the predetermined distance.

Note that the estimation of the degree of contamination and tarnishing performed by the estimation section 320 is not limited to the examples described above. For example, the estimation section 320 may estimate the degree of contamination and tarnishing by inputting the travel information of the vehicle 12 and the environment information at the location at which the vehicle 12 has been present into an estimation model learned from the travel information of plural vehicles, the environment information at the position at which each of the plural vehicles have been present, and the actual degree of contamination and tarnishing, as a dataset.

The notification section 330 notifies the user of a timing for at least one of a vehicle wash or a vehicle inspection based on the estimation result by the estimation section 320. As the notification means, an output device (not illustrated) such as a display, a speaker, or the like which is provided in the center server 30 can be used.

More specifically, as an example, in a case in which the degree of contamination and tarnishing of the vehicle 12 caused by the amount of time spent in an area including a road on which yellow sand, volcanic ash, or the like is present has reached or exceeded a predetermined value, the notification section 330 notifies the user of a timing for a vehicle wash. Further, as an example, in a case in which the degree of contamination and tarnishing of the vehicle 12 caused by an area where rain, snow, or the like is falling, namely, a long travel distance on a rough roa, has reached or exceeded a predetermined value, the notification section 330 notifies the user of a timing for a vehicle wash. Furthermore, as an example, in a case in which the degree of contamination and tarnishing of the vehicle 12 caused by a long travel time or a long amount of time spent on a coastal road or a snow-covered road has reached or exceeded a predetermined value, the notification section 330 notifies the user of a timing for a vehicle wash.

Note that the notification section 330 of the present exemplary embodiment refers to the vehicle wash history of the vehicle 12 which is stored in the ROM 30B to notify the user of a timing for a vehicle wash in a case in which the degree of contamination and tarnishing of the vehicle 12 after the previous vehicle wash has reached or exceeded the predetermined value described above. At this time, the predetermined value is set with reference to the maintenance history of the vehicle 12 which is stored in the ROM 30B, in consideration of information as to whether or not the vehicle 12 has been coated, or information such as the date and time when the vehicle body was last coated.

As an example, in a case in which the degree of contamination and tarnishing caused by a long travel time or a long amount of time spent on a coastal road or a snow-covered road has reached or exceeded a predetermined value, the notification section 330 notifies the user of a timing for a vehicle inspection. Namely, since there is a possibility of salt damage to components and the like of the vehicle 12 in a case in which the vehicle has traveled on a coastal road, a vehicle inspection is proposed to the user. Further, on snow-covered roads, chloride-based substances such as sodium chloride and calcium chloride are sprayed as anti-freezing agents in order to prevent the roads from freezing. Accordingly, in a case of traveling on a snow-covered road, there is a possibility of salt damage to components and the like of the vehicle 12, and therefore, a vehicle inspection is proposed to the user.

Note that the notification section 330 of the present exemplary embodiment refers to the maintenance history of the vehicle 12 which is stored in the ROM 30B, and notifies the user of a timing for a vehicle inspection in a case in which the degree of contamination and tarnishing of the vehicle 12 after the previous vehicle inspection has reached or exceeded the predetermined value described above.

As an example, in a case in which the degree of contamination and tarnishing caused by a long travel distance on an unpaved road with irregularities or the like has reached or exceeded a predetermined value, the notification section 330 notifies the user of a timing for a vehicle inspection. More specifically, since the item requiring inspection is the tires, notification of a timing for tire replacement is provided. Note that the notification section 330 of the present exemplary embodiment refers to the maintenance history of the vehicle 12 which is stored in the ROM 30B, and notifies the user of a timing for tire replacement in a case in which the degree of contamination and tarnishing after the previous tire replacement has reached or exceeded the predetermined value described above.

Moreover, as an example, in a case in which the degree of contamination and tarnishing, caused by a case in which the travel distance of the vehicle 12, per unit time, is equal to or less than a predetermined distance, has reached or exceeded a predetermined value, the notification section 330 notifies the user of a timing for a vehicle inspection. More specifically, notification of a timing for inspecting or replacing the engine oil or the battery is provided. Note that the notification section 330 of the present exemplary embodiment refers to the maintenance history of the vehicle 12 which is stored in the ROM 30B, and notifies the user of a timing for replacing the engine oil or battery in a case in which the degree of contamination and tarnishing after the previous replacement of the engine oil or battery has reached or exceeded the predetermined value.

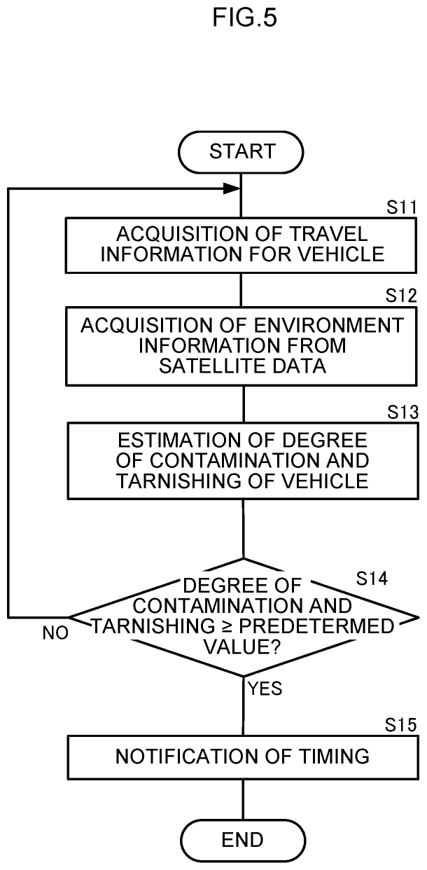

Next, explanation follows regarding a flow of notification processing, with reference to FIG. 5. The notification processing is performed by the CPU 30A reading an output program from the ROM 30B, and loading and executing the output program in the RAM 30C. Note that the satellite server 10 sequentially acquires and accumulates satellite data.

As illustrated in FIG. 5, first, at step S11, the travel information acquisition section 300 acquires travel information of the vehicle 12 in the manner described above. Next, at step S12, the environment information acquisition section 310 acquires the environment information at the location at which the vehicle 12 has been present, from the satellite data acquired from the satellite server 10, in the manner described above.

At step S13, the estimation section 320 estimates the degree of contamination and tarnishing of the vehicle 12 in the manner described above. Next, the notification section 330 determines whether or not the degree of contamination and tarnishing estimated by the estimation section 320 is equal to or greater than a predetermined value. In a case in which the degree of contamination and tarnishing is less than the predetermined value (step S14; NO), the notification section 330 transitions to the processing of step S11.

On the other hand, at step S14, in a case in which the degree of contamination and tarnishing is equal to or greater than the predetermined value (step S14; YES), the notification section 330 provides notification of a timing for at least one of a vehicle wash or a vehicle inspection of the vehicle 12 in the manner described above, and ends the processing. Note that in a case in which, for example, there is a degree of contamination and tarnishing due to plural causes, the notification section 330 sets an item (for example, tire, engine oil, battery, a vehicle wash, or the like) corresponding to the degree of contamination and tarnishing, which has reached or exceeded a predetermined value, as a necessary item, and provides notification of a timing for a vehicle wash, a vehicle inspection, a component replacement, or the like with respect to the necessary item.

Next, explanation follows regarding operation and advantageous effects of the center server 30 serving as a notification device in the present exemplary embodiment.

The center server 30 of the present exemplary embodiment acquires, from the satellite data, environment information at a location at which the vehicle 12 has been present, based on the travel information of the vehicle 12. The estimation section 320 then estimates the degree of contamination and tarnishing of the vehicle 12 based on the environmental information, and based on the estimation result, notifies the user of a timing for at least one of a vehicle wash or a vehicle inspection. This enables the user to be informed of a timing for a vehicle wash and/or a vehicle inspection based on the degree of contamination and tarnishing of the vehicle 12. This enables the user to perform a vehicle wash and/or a vehicle inspection at an appropriate timing, enabling the operating life of the vehicle 12 to be extended.

Moreover, according to the center server 30 of the present exemplary embodiment, in a case in which the vehicle 12 has traveled on at least one of a road on which yellow sand or volcanic ash is present, a rough road, an unpaved road, a coastal road, or a snow-covered road, the estimation section 320 sets the degree of contamination and tarnishing higher than a case in which the vehicle 12 does not travel on the at least one of a road on which yellow sand or volcanic ash is present, a rough road, an unpaved road, a coastal road, or a snow-covered road. Accordingly, in a case in which the vehicle 12 has traveled on a road that causes contamination and tarnishing, including soiling, degradation, wear, and the like, the degree of contamination and tarnishing becomes higher, enabling the user to be informed of an appropriate timing for a vehicle wash and/or a vehicle inspection in accordance with the environmental information at the location at which the vehicle 12 has been present.

Moreover, according to the center server 30 of the present exemplary embodiment, the estimation section 320 further increases the degree of contamination and tarnishing in a case in which the vehicle 12 has traveled so-called short distances. In general, when the vehicle 12 travels short distances, it is desired that the engine oil and/or the battery is replaced at a shorter cycle than usual. Therefore, according to the center server 30 of the present exemplary embodiment, information as to whether or not the vehicle 12 has undergone short-distance travel is also considered for the timing for a vehicle inspection, enabling the user to be informed of a more appropriate timing for a vehicle inspection.

Moreover, according to the center server 30 of the present exemplary embodiment, based on the maintenance history of the vehicle 12, the notification section 330 provides notification of a timing for a vehicle wash and/or a vehicle inspection with respect to required items, the user is able to know the necessary timing for a vehicle wash and/or a vehicle inspection

Moreover, according to the center server 30 of the present exemplary embodiment, the travel information acquisition section 300 can acquire travel information of the vehicle 12 based on satellite data acquired by capturing a code that is disposed at an upper part of the vehicle 12 and that identifies the vehicle 12. This enables the vehicle 12 to be identified from the satellite data acquired by capturing the code, thereby enabling travel information of the vehicle 12 to be acquired from the satellite data acquired in chronological order.

Notes

Note that in the above-described exemplary embodiments, the center server 30 which is configured separately from the vehicle 12 is applied as the notification device. However, the present disclosure is not limited to this example. A device incorporated in the vehicle 12 may be applied as the notification device. Alternatively, a user terminal possessed by a user may be applied instead of the vehicle 12. In this case, a device incorporated in the user terminal may be applied as the notification device.

Moreover, in the above-described exemplary embodiments, satellite data is accumulated in the satellite server 10 that is configured separately from the center server 30. However, the present disclosure is not limited to this example. Satellite data may be accumulated in a storage device such as the ROM 30B or storage included in the center server 30.

Further, in the above-described embodiments, any of various types of processors other than a CPU may execute the processing that the CPU executes by reading software (a program). Examples of such processors include a Programmable Logic Device (PLD) in which the circuit configuration can be modified post-manufacture, such as a Field-Programmable Gate Array (FPGA), or a specialized electric circuit that is a processor with a specifically-designed circuit configuration for executing specific processing, such as an Application Specific Integrated Circuit (ASIC). Further, the above-described processing may be executed by one of these various types of processors, or may be executed by combining two or more of the same type or different types of processors (for example, plural FPGAs, or a combination of a CPU and an FPGA, or the like). Further, a hardware configuration of the various processors is specifically formed as an electric circuit combining circuit elements such as semiconductor elements.

Further, although explanation has been given regarding an aspect in which the respective programs are stored (installed) in advance in the ROM in the above-described exemplary embodiments, there is no limitation thereto. The programs may be provided in a format recorded on a recording medium such as compact disc read only memory (CD-ROM), digital versatile disc read only memory (DVD-ROM), or universal serial bus (USB) memory. Alternatively, the programs may be provided in a format downloadable from an external device over a network.

The flow of processing described in the above-described exemplary embodiments is an example, and unnecessary steps may be deleted, new steps may be added, or the processing order may be rearranged within a range not departing from the technical scope of the present disclosure.

The configurations of the satellite server 10, the vehicle 12, and the center server 30 described in the above-described exemplary embodiments are examples, and may be modified according to circumstances within a range not departing from the technical scope of the present disclosure.

What is claimed is:

1. A notification device comprising:
a travel information acquisition section that is configured to acquire travel information of a vehicle;
an environment information acquisition section that is configured to acquire, from satellite data, environment information at a location at which the vehicle has been present, based on the travel information of the vehicle which is acquired by the travel information acquisition section;
an estimation section that is configured to estimate a degree of contamination and tarnishing of the vehicle based on the environment information which is acquired by the environment information acquisition section; and
a notification section that is configured to notify a user of the vehicle of a timing for at least one of a vehicle wash or a vehicle inspection, based on an estimation result by the estimation section.

2. The notification device according to claim 1, wherein:
in a case in which the vehicle has traveled on at least one of a road on which yellow sand or volcanic ash is present, a rough road, an unpaved road, a coastal road or a snow-covered road, the estimation section is configured to set the degree of contamination and tarnishing higher than a case in which the vehicle has not traveled on the at least one of a road on which yellow sand or volcanic ash is present, a rough road, an unpaved road, a coastal road or a snow-covered road.

3. The notification device according to claim 1, wherein:
in a case in which a travel distance of the vehicle, per unit time, is equal to or less than a predetermined distance, the estimation section is configured to set the degree of contamination and tarnishing higher than a case in which the travel distance of the vehicle, per unit time, is greater than the predetermined distance.

4. The notification device according to claim 1, wherein:
the notification section is configured to provide notification of the timing with respect to a necessary maintenance item and a vehicle wash, based on at least one of a maintenance history of the vehicle or a wash history of the vehicle.

5. The notification device according to claim 1, wherein:
the travel information acquisition section is configured to acquire the travel information of the vehicle based on satellite data acquired by capturing a code that is disposed at an upper part of the vehicle and that identifies the vehicle.

6. A notification device for maintenance and safe travel of a vehicle, the notification device comprising:
a memory; and
a processor coupled to the memory, wherein the processor is configured to:
acquire travel information of a vehicle;
acquire, from satellite data, environment information at a location at which the vehicle has been present, based on the travel information of the vehicle;
estimate a degree of contamination and tarnishing of the vehicle based on the environment information; and
notify a user of a timing for at least one of a vehicle wash or a vehicle inspection, based on an estimation result.

7. The notification device according to claim 6, wherein:
in a case in which the vehicle has traveled on at least one of a road on which yellow sand or volcanic ash is present, a rough road, an unpaved road, a coastal road or a snow-covered road, the processor is configured to set the degree of contamination and tarnishing higher than a case in which the vehicle has not traveled on the at least one of a road on which yellow sand or volcanic ash is present, a rough road, an unpaved road, a coastal road or a snow-covered road.

8. The notification device according to claim 6, wherein:
in a case in which a travel distance of the vehicle, per unit time, is equal to or less than a predetermined distance, the processor is configured to set the degree of contamination and tarnishing higher than a case in which the travel distance, per unit time, is greater than the predetermined distance.

9. The notification device according to claim 6, wherein:
the processor is configured to provide notification of the timing with respect to a necessary maintenance item and a vehicle wash, based on at least one of a maintenance history of the vehicle or a wash history of the vehicle.

10. The notification device according to claim 6, wherein:
the processor is configured to acquire the travel information of the vehicle based on satellite data acquired by capturing a code that is disposed at an upper part of the vehicle and that identifies the vehicle.
